(19) United States
(12) Patent Application Publication
(10) Pub. No.: US 2026/0213293 A1
(43) Pub. Date: Jul. 23, 2026

(54) Means of Transportation, Cell Packet and Method for Repairing a Cell Packet

(71) Applicant: Bayerische Motoren Werke Aktiengesellschaft, Muenchen (DE)

(72) Inventors: Christoph JAGODA, Essenbach (DE); Hanno PFITZER, Furth (DE); Ann-Marie REICHERSAMMER, Niederaichbach (DE)

(21) Appl. No.: 19/141,712

(22) PCT Filed: Dec. 21, 2023
(86) PCT No.: PCT/DE2023/100987

§ 371 Date: Jun. 20, 2025

(30) Foreign Application Priority Data
Jan. 3, 2023 (DE) 10 2023 100 047.0

(51) Int. Cl. H01M 10/54; B60L 50/64; H01M 10/04; H01M 50/112; H01M 50/249

(52) U.S. Cl. CPC H01M 10/54; H01M 10/0431; H01M 10/049; H01M 50/112; H01M 50/249; B60L 50/64; H01M 2220/20

(57) ABSTRACT

A method for repairing a cell packet comprises the steps of: opening a defective storage cell, removing a jelly roll from a cell container of the defective storage cell, inserting a new storage cell into the cell container and electrically incorporating the new storage cell into the cell packet.

### BACKGROUND AND SUMMARY

The present disclosure relates to a means of transportation, a cell packet, and a method for repairing a cell packet which has a plurality of storage cells. In particular, the present disclosure relates to the repair of a cell packet in which individual cells are glued and/or foamed into a composite in order to assume mechanically load-bearing functions.

The electrification of individual passenger transportation is currently progressing rapidly. In order to use the commonly used high-voltage batteries, which add considerable weight to the vehicle, not only for storing traction energy but also for performing structural tasks, individual cells are bonded and/or foamed together to create load-bearing components. Modern high-voltage storage systems with high power density are no longer constructed in a modular fashion, but as a highly integrated cell system with a structural function. To ensure this structural function, the cells are firmly and sometimes irreversibly connected to each other, which can reduce the overall mass of the vehicle, but makes it considerably more difficult to repair or replace individual parts. One difficulty with highly integrated cell systems is the inability to separate the individual cells without destroying the cell contacts, cooling lines, carrier systems, cells, cell connection technology, etc. Repair at cell level is therefore virtually impossible.

Due to the highly integrated design to fulfill the structural integrity in the event of a crash load, a large-area connection of the cells is necessary. Typical separation methods destroy either the cooling and/or the housing and the positioning aids of the cells. A local repair solution without completely dismantling the high-voltage storage system is therefore not possible, which is why the entire high-voltage storage system often has to be replaced.

Based on the aforementioned prior art, it is an object of the present disclosure to be able to rectify any defects or reduced performance of one or more cells of a high-voltage storage system without destroying or damaging the structural integrity of the system.

The cell packet can be designed as a high-voltage storage system for providing traction energy for a means of transportation or a work machine. It has a large number of individual storage cells that contribute to the terminal voltage of the cell packet. These storage cells can, for example, have round cells, flat cells or other cell types (e.g., prismatic cells). They have an electrode unit, which in the case of a round cell, for example, can be designed as a jelly roll (electrode coil). Once the defective storage cell has been identified, it is opened. The jelly roll is then removed from the cell container and any remaining residue is removed. The cell container of the defective storage cell can also be rinsed or wiped out for this purpose. A new storage cell is then inserted into the cell container. This cell container of the defective storage cell therefore remains in the cell packet and is filled with a complete new storage cell. The new storage cell is then integrated into the cell packet. The electrical connections are connected to the other cells in the cell packet in the same way as the defective cell was integrated. Ideally, therefore, only the contacts to the defective storage cell or its cell lid are disconnected and then connected to the corresponding positions on the new storage cell (e.g. soldered or plugged/clamped). In order to be able to insert the new storage cell into the remaining cell container, the new storage cell can have a slightly smaller outer diameter than the defective storage cell. This considerably simplifies the replacement process. Two effects favor the use of a new storage cell with a reduced overall volume: On the one hand, the development of storage cells and cell chemistry is currently progressing rapidly, so that it can be expected that new storage cells can theoretically show similar electrical performance and properties in a smaller volume as storage cells manufactured at an earlier point in time. In addition, the larger storage cells (already degraded in operation) of the cell packet may already have been affected in terms of their initial properties, so that an equivalent smaller storage cell can take over the role of the defective storage cell even if it has a smaller volume. The method according to the disclosure allows a cell packet to be repaired quickly and easily.

The new storage cell can be coated with a thermally conductive paste and/or an adhesive (resin) before being inserted into the remaining cell container in order to fit perfectly into the cell packet composite. In this way, the new storage cell can take the place of the defective storage cell both thermally and statically.

The defective storage cell can be a round cell. This type has a particularly high static load capacity and is manufactured in bulk. This means that the cell packet can be repaired at a particularly low cost.

Preferably, the storage cells of the cell packet can be foamed and/or glued into the cell packet. This results in an overall rigidity that is helpful for the statics of the entire vehicle. Once the cell container of the defective storage cell has been completely emptied, it can be slotted using a special tool to make it easier to fit the new storage cell. In other words, the remaining cell container can be widened by pressing the new storage cell into it. By slotting/weakening the old cell container, it is possible to prevent excessive forces from acting on the new storage cell. It can also prevent the new storage cell from having to have too small a total volume.

After the electrical connections of the defective storage cell have been removed, the lid of the defective storage cell can be cut off or drilled out. This may involve machining using a rotating tool. Care may be required here to ensure that any chips or burrs produced do not pose a risk to the electrical periphery of the defective storage cell. It is therefore preferable to ensure that the periphery is protected from flying chips, electrolyte drops, etc. For example, a layer (film, cover, sheet metal, plastics layer, etc.) can be temporarily applied to cover the periphery surrounding the defective storage cell to make it easier to replace the jelly roll.

In particular, the lid can be cut/drilled open on the end face so that the cell container of the defective storage cell remains permanently in the cell packet during an execution of the entire method according to the disclosure. In other words, an integrally bonded connection between the cell container and the periphery (foam, adhesive, etc.) is not dissolved and remains in place even in the course of continued use of the cell packet.

Put simply, the structural integrity of the cell packet is completely preserved, while only the cell contact is detached and the lid of the defective cell is removed. The defective cell packet is removed without the cell envelope and replaced by a new (possibly slightly smaller) intact adapted cell. The cell contact is renewed or restored locally.

The cell container of the new storage cell can have an identical or, in particular, a slightly shorter overall length than the cell container of the defective storage cell. This ensures the best possible fit. In particular, it can be ensured that the new storage cell protrudes from the cell packet, as it cannot be inserted over its entire length into the cell container of the defective storage cell. This means that the dimensions of the cell packet are not significantly altered by the repair.

According to a second aspect of the present disclosure, a cell packet is proposed which comprises a plurality of storage cells in a respective cell container. The cell containers have a first inner diameter and contain a respective jelly roll, which contains the actual cell chemistry. One of the storage cells may have been repaired according to the method described above. Therefore, it has an additional inner cell container not contained in the other storage cells, wherein the inner cell container has a smaller inner diameter than the outer cell container. The inner cell container is closed by a cell lid. The jelly roll contained in the inner cell container is hermetically sealed by the lid and can be electrically contacted to the outside. In particular, a thermally conductive paste, a resin, an adhesive or a combination of the aforementioned is provided between the inner cell container and the outer cell container. This means that the repaired cell packet can continue to be used, eliminating the cost of completely replacing the defective cell packet. The features, combinations of features and the advantages resulting from them correspond so obviously to those of the method described above that reference is made to the above explanations in order to avoid repetition.

Preferably, the inner cell container can have an outer diameter which is substantially identical to the first inner diameter (inner diameter of the outer cell container). Preferably, the inner cell container can be pressed into the outer cell container, wherein the outer cell container has been widened by inserting the inner cell container. In order to reduce the forces occurring during expansion or to keep them below a predefined limit, the outer cell container can be slotted. It may contain residues of electrolyte, which are located between the inner cell container and the outer cell container.

Only the inner cell container is closed by a lid. In other words, the outer cell container contains a complete intact storage cell, which is connected to the outer cell container at least by frictional engagement, in particular in an integrally bonded manner. The lid of the inner cell container is optionally connected to the electrical periphery within the cell packet.

According to a third aspect of the present disclosure, a means of transportation is proposed which has a cell packet according to the second-mentioned aspect of the invention. The cell packet may, for example, be provided as a traction energy storage device and/or be arranged in a floor assembly of the means of transportation. The cell packet can be glued and/or foamed into the floor assembly in order to contribute to the rigidity of the floor assembly. The means of transportation can be provided as a purely electrically and/or hybrid powered means of transportation. The features, combinations of features and advantages are therefore also evident for the means of transportation in such a way that reference is made to the above explanations in order to avoid repetition.

Further details, features and advantages of the disclosure are shown in the following description and the figures, in which:

### BRIEF DESCRIPTION OF DRAWINGS

FIG. 1 is a perspective view of a repair process of a cell packet;

FIG. 2 is a flowchart illustrating steps of an exemplary embodiment of a method according to the disclosure for repairing a cell packet; and

FIG. 3 is an overview of a means of transportation according to an exemplary embodiment of the present disclosure.

### DETAILED DESCRIPTION OF DRAWINGS

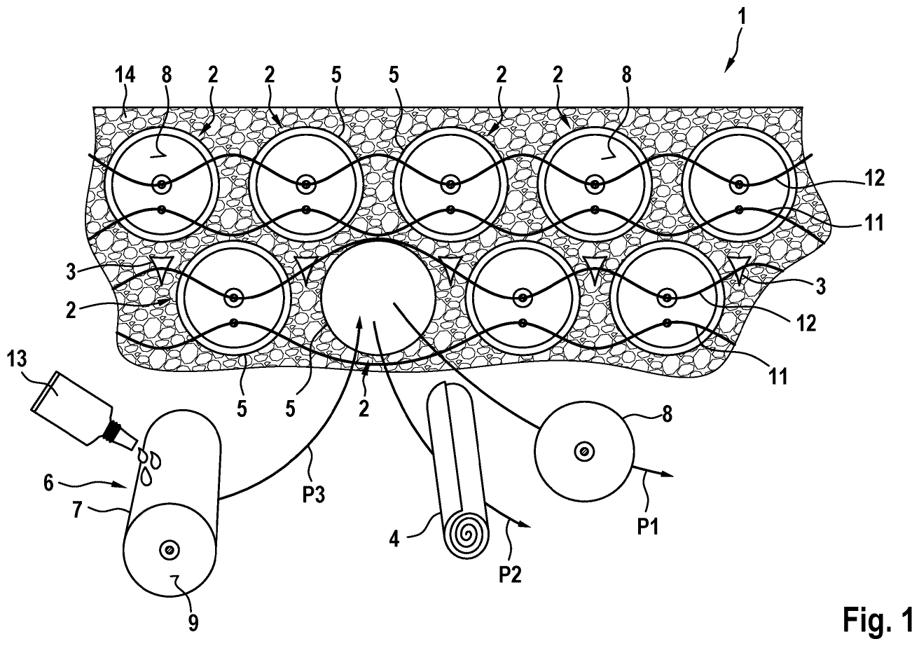

FIG. 1 shows a cell packet 1 that can be used as a traction energy storage unit in a means of transportation (see FIG. 3, reference sign 10). The storage cells 2 have cell containers 5, which are glued into a surrounding foam structure 14. The cell containers 5 are closed in the direction of the observer by respective lids 8. Electrical connections 11, 12 are also soldered to the lids 8 and supply electrical energy to a traction machine or from a charger. Cooling channels 3 are provided between the cell containers 5 in order to dissipate the waste heat generated in the storage cells. The replacement of a defective storage cell 2 is also shown. The cell lid 8 has been removed, as shown by an arrow P1. The jelly roll 4 has then been removed from the cell container 5, which is still glued into the foam structure 14, as shown by an arrow P2. Subsequently, a somewhat thinner and shorter new storage cell 6 is prepared by applying a thermally conductive paste 13 in order to be inserted into the now empty cell container 5 as shown by an arrow P3. Since the cell container 7 of the new storage cell 6 has a smaller diameter and a slightly shorter length than the other cell containers 5, the new storage cell 6 can now be inserted into the empty cell container 5 and connected to the electrical lines 11, 12. The new storage cell 6 is specially closed with a lid 9, which naturally also has a slightly smaller diameter than the lid 8. The lid 9 therefore only closes the new storage cell 6, but not the old cell container 5. Once the thermally conductive paste 13 has cured, the new storage cell 6 is permanently and securely thermally integrated into the cell packet 1. The cell packet 1 can now be used again in a means of transportation 10 to provide traction energy.

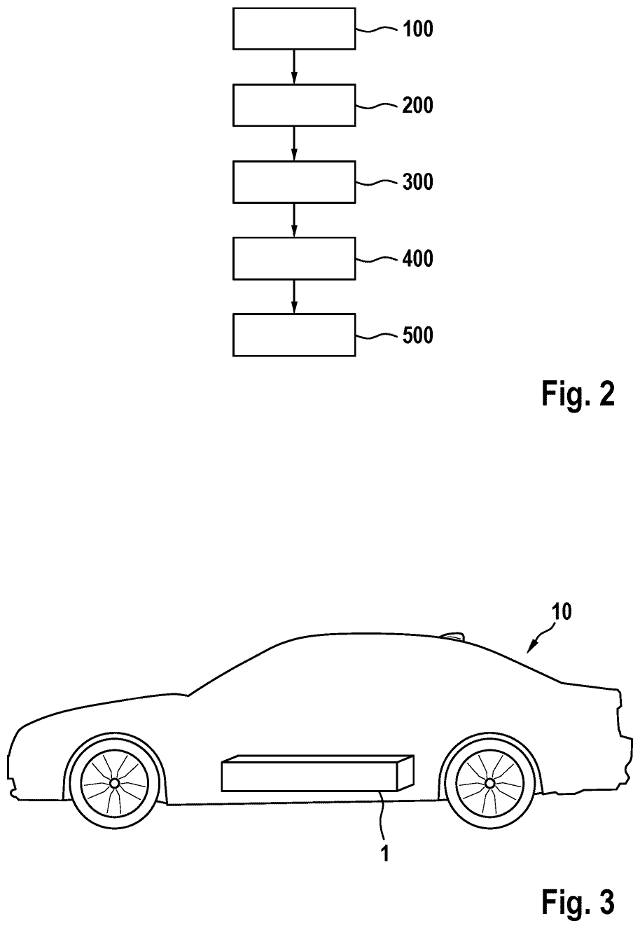

FIG. 2 shows steps of an exemplary embodiment of a method according to the disclosure for repairing a cell packet. In step 100, a defective storage cell is opened. For this purpose, the lid of the defective storage cell is removed in step 200. Here, a rotating cutting tool similar to a can opener can fully cut into the front of the defective cell. In step 300, the jelly roll is removed from the cell container of the defective storage cell. In addition, the now empty cell container can be cleaned of any remaining electrolyte and other residues. In step 400, a new storage cell is inserted into the cell container. The new storage cell has its own (slightly thinner) cell container. Lastly, in step 500, the new storage cell is also electrically integrated into the cell packet. For example, the wires removed from the defective storage cell are connected to the electrodes of the new storage cell (particularly at the front).

FIG. 3 shows an exemplary embodiment of a means of transportation 10 according to the invention in the form of a passenger car, in the floor assembly of which a cell packet 1 is installed. Alternatively, the means of transportation 10 may be another vehicle type, such as truck, utility vehicle, etc. The cell packet 1 is firmly foamed/glued and/or cast into the floor assembly in such a way that it not only provides traction energy, but can also contribute to stiffening the floor assembly of the way of transportation 10.

### LIST OF REFERENCE SIGNS

1 cell packet
2 storage cell
3 cooling channel
4 jelly roll
5 cell container
6 new storage cell
7 cell container of the new storage cell
8 lid of the storage cell
9 lid of the new storage cell
10 means of transportation
11, 12 electrical cable
13 thermally conductive paste
14 foam structure
100 to 500 method steps
P1 to P3 arrows

1.-11. (canceled)

12. A method for repairing a cell packet having a plurality of storage cells, the method comprising:
opening a defective storage cell,
removing a jelly roll from a cell container of the defective storage cell,
inserting a new storage cell into the cell container, and
electrically incorporating the new storage cell into the cell packet.

13. The method according to claim 12, wherein the defective storage cell is a round cell.

14. The method according to claim 12, wherein the storage cells are glued into the cell packet.

15. The method according to claim 12, wherein the new storage cell has a cell container which has smaller dimensions than the cell container of the defective storage cell.

16. The method according to claim 12, further comprising removing a cover of the defective storage cell.

17. The method according to claim 12, wherein the cell container of the defective storage cell remains permanently in the cell packet during execution of the method.

18. The method according to claim 12, wherein the cell container of the new storage cell has a total length identical to or shorter than the cell container of the defective storage cell.

19. A cell packet having a plurality of storage cells with a respective cell container which has a first inner diameter, and wherein at least one storage cell additionally has an inner cell container, wherein the inner cell container has a second inner diameter which is smaller than the first inner diameter.

20. The cell packet according to claim 19, wherein the inner cell container has an outer diameter which is substantially identical to the first inner diameter.

21. The cell packet according to claim 19, wherein the inner cell container is closed by a lid.

22. A means of transportation comprising a cell packet according to claim 19.
